(19) United States
(12) Patent Application Publication
(10) Pub. No.: US 2012/0185107 A1
(43) Pub. Date: Jul. 19, 2012

(54) POWER DISTRIBUTION SYSTEM

(75) Inventors: Kiyotaka Takehara, Nara (JP); Yasuhiro Yanagi, Osaka (JP); Akiko Takamiya, Osaka (JP)

(73) Assignee: Panasonic Electric Works Co., Ltd., Osaka (JP)

(21) Appl. No.: 13/496,283

(22) PCT Filed: Aug. 31, 2010
(86) PCT No.: PCT/IB10/02144

§ 371 Date: Apr. 9, 2012

(30) Foreign Application Priority Data
Sep. 15, 2009 (JP) 2009-213501

(51) Int. Cl. G05F 5/00

(52) U.S. Cl. 700/292; 700/286

(57) ABSTRACT

A power distribution system includes power sources and an outlet which is supplied with electric power from the power sources and displays information on which power source is currently supplying the electric power. Further, the power distribution system includes a controller which changes the power sources for supplying the electric power to the outlet and controls the display on the outlet.

### FIELD OF THE INVENTION

The present invention relates to a power distribution system.

### BACKGROUND OF THE INVENTION

Alternative current (AC) appliances such as an air conditioner, a refrigerator and a washing machine are supplied with electric power from a commercial power source (AC power source). A direct current (DC) appliance such as a personal computer, a liquid crystal television, a telephone or a facsimile is driven by a DC power source. There are proposed techniques for employing both an AC power distribution system for supplying AC electric power and a DC power distribution system for supplying DC electric power in a house or store. (see, e.g., Japanese Patent Application Publication No. 2009-178025)

In a power distribution system in a house, generally, a commercial power source, a solar battery, a secondary cell charged with surplus electric power or the like is used to supply electric power to the appliances. Further, the system changes the power sources for supplying the electric powers to the appliances based on amounts of the electric power supply and demand. For example, if the charged electric power from the secondary cell and/or the electric power generated from the solar battery are/is sufficient, the charged electric power from the secondary cell or the electric power generated from the solar battery is supplied to not only DC appliances but also to AC appliances by using an inverter for converting DC electric power into AC electric power. Further, if the charged electric power from the secondary cell or the electric power generated from the solar battery is insufficient, the commercial power source can be jointly used to supply electric power to AC appliances as well as to DC appliances by using a converter for converting AC electric power into DC electric power.

As described above, the power sources to supply electric power to the appliances are changed based on the electric power supply amounts from the power sources and the electric power demand amount by the appliances. However, no system has configuration for notifying a user of change of power sources such that the user can easily perceive it.

### SUMMARY OF THE INVENTION

In view of the above, the present invention provides a power distribution system capable of notifying a user of change of power sources such that the user can easily perceive it.

In accordance with an aspect of the present invention, there is provided a power distribution system including power sources; an outlet which is supplied with electric power from the power sources and displays information on which power source is currently supplying the electric power; and a controller which changes the power sources for supplying the electric power to the outlet and controls the display on the outlet. The power sources include a commercial power source, a distributed power source and a secondary cell charged by the commercial power source and/or the distributed power source, and the outlet includes a display unit for displaying the information on which power source is currently supplying the electric power.

Further, the controller includes a power distribution control unit for changing the power sources for supplying the electric power to the outlet based on at least one of power supply amounts of the power sources and a power demand amount on a side of the outlet, and a display control unit for changing the display of the display unit of the outlet correspondingly to the power sources currently used to supply the electric power to the outlet.

With this configuration, it is possible to easily notify the user of the change of the power sources, and to motivate the user to save electric power and reduce the electricity rate.

In the power distribution system, the power distribution control unit may perform a power distribution control mode using a power source including the commercial power source or a power distribution control mode using a power source other than the commercial power source, and the display control unit changes the display of the display unit of the outlet corresponding to one of the power distribution control modes.

By this configuration, the power distribution control can be appropriately performed by changing modes depending on whether or not a commercial power source is used as a power source, and the display control can be appropriately performed corresponding to the mode of the power distribution control unit.

Preferably, the distributed power source includes a solar battery, the power distribution control unit performs a power distribution control mode using only the solar battery, a power distribution control mode using the solar battery and the secondary cell or a power distribution control mode using a power source including the commercial power source, and the display control unit changes the display of the display unit of the outlet corresponding to one of the power distribution control modes.

Accordingly, since the display control is performed based on the uses of the solar battery, the secondary cell and the commercial power source, it is possible to suppress the power consumption of the commercial power source and reduce the electricity rates.

Further, the distributed power source may include a solar battery, the power distribution control unit may perform a first power distribution control mode using only the solar battery, a second power distribution control mode using the solar battery and the secondary cell, a third power distribution control mode using the solar battery, the secondary cell and the commercial power source, a fourth power distribution control mode using the solar battery and the commercial power source or a fifth power distribution control mode using only the commercial power source. The display control unit may change the display of the display unit of the outlet corresponding to one of the first to fifth the power distribution control modes.

By this configuration, the modes using the commercial power source, the solar battery and the secondary cell are subdivided and the display control is performed based on the uses of the solar battery, the secondary cell and the commercial power source. Accordingly, it is possible to suppress the power consumption of the commercial power source and reduce the electricity rates.

The commercial power source may have different electricity rates at different times during a day, and if the power sources currently used to supply the electric power to the outlet include the commercial power source, the display control unit may change the display of the display unit of the outlet to correspond to an electricity rate of the commercial power source at a current time.

Accordingly, it is possible to encourage the user to save electric power and reduce the electricity rate by varying the display depending on different electricity rates during different times of the day.

Further, in the power distribution system, the display control unit may change the display of the display unit of the outlet before changing the power sources for supplying the electric power to the outlet.

By this configuration, the user can be informed in advance of the conversion of power sources. Accordingly, the user can take actions (e.g., power on/off and adjustment) for electric power saving and reduction of electricity rates as soon as possible.

### BRIEF DESCRIPTION OF THE DRAWINGS

The objects and features of the present invention will become apparent from the following description of embodiments, given in conjunction with the accompanying drawings, in which:

FIG. 1 illustrates a configuration of a power distribution system in accordance with an embodiment of the present invention;

FIGS. 2A and 2B illustrate configurations of an AC and a DC outlet shown in FIG. 1, respectively; and

FIGS. 3A and 3B illustrate other configurations of an AC and a DC outlet.

### DETAILED DESCRIPTION OF THE EMBODIMENTS

Hereinafter, embodiments of the present invention will be described in detail with reference to the accompanying drawings which form a part hereof. Like parts are denoted by like reference numerals in the drawings, and redundant descriptions thereof will be omitted.

### First Embodiment

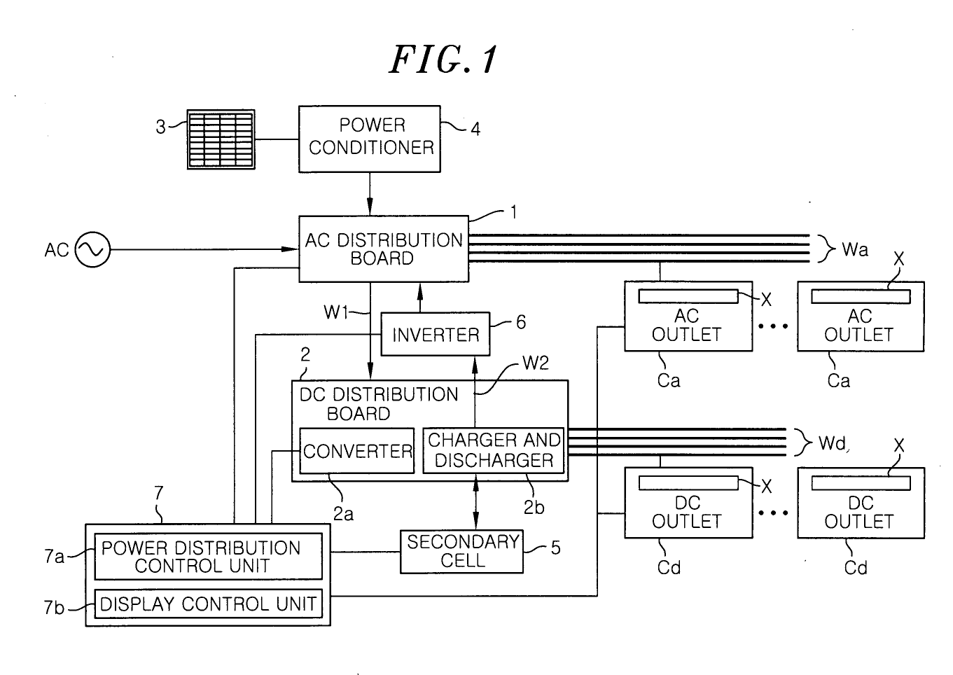

FIG. 1 shows a power distribution system in accordance with a first embodiment of the present invention which is applied to a house, for example. The power distribution system includes an AC distribution board 1 connected to an AC power feed line Wa having an AC outlet Ca serving as an electric power outlet, which is connected to an AC appliance (not shown), and a DC distribution board 2 connected to a DC power feed line Wd having a DC outlet Cd serving as an electric power outlet, which is connected to a DC appliance (not shown). Further, power sources of the system include a commercial AC power source serving as an AC power source and at least one of a solar battery 3 and a secondary cell 5 serving as a DC power source.

Hereinafter, the present invention will be described as an example applied to a detached independent house, but it is not limited thereto and it may be applied to an apartment, an office, a factory and the like.

The AC distribution board 1 connected to the AC power feed line Wa is supplied with an AC electric power from the commercial AC power source. An AC electric power from the solar battery 3 serving as a distributed power source is also supplied to the AC distribution board 1 via a power conditioner 4 (first power conversion unit). The AC distribution board 1 includes a main breaker, branch breakers, switches and the like, which are not shown in the drawing, and supplies an AC electric power to an AC connection line W1 and the AC power feed line Wa that is branched into grids at the load side of the branch breakers. Further, the power conditioner 4 converts a DC electric power generated by the solar battery 3 into an AC electric power and adjusts an output frequency and an output voltage thereof in order to allow a grid-connection with the commercial AC power source.

Meanwhile, the DC distribution board 2 connected to the DC power feed line Wd is supplied with an AC electric power from the AC distribution board 1 via the AC connection line W1. The DC distribution board 2 includes a converter 2a (second power conversion unit) for converting an AC electric power into a DC electric power at a desired output voltage. The converter 2a serves as an AC-DC conversion unit, and an output of the converter 2a is supplied to grids of the DC power feed line Wd via circuit protectors, switches and the like which are included in the board and not shown in the drawing.

The DC distribution board 2 further includes a charger and discharger 2b connected between the output of the converter 2a and the secondary cell 5 to charge and discharge the secondary cell 5. The charger and discharger 2b controls to charge the secondary cell 5 with a surplus electric power after supplying the DC electric power from the converter 2a to the DC power feed line Wd. Further, an output voltage of the secondary cell 5 is adjusted by the charger and discharger 2b such that an electric power thereof can be supplied to the DC power feed line Wd together with the DC electric power outputted from the converter 2a.

Each of the DC electric powers outputted from the converter 2a and the secondary cell 5 as described above is also supplied to an inverter 6 (third power conversion unit) via a DC connection line W2. The inverter 6 is a DC-AC conversion unit having a function of adjusting an output frequency and an output voltage of each of the DC electric powers outputted from the converter 2a and the secondary cell 5 to allow a grid-connection with the commercial AC power source. The inverter 6 converts a DC electric power into an AC electric power and supplies the AC electric power to the AC power feed line Wa via the branch breakers in the AC distribution board 1.

As clearly seen from the above-described configuration, an AC electric power can be supplied from the AC distribution board 1 to the DC distribution board 2, and the AC electric power can be converted into a DC electric power by the converter 2a to be supplied to the DC power feed line Wd. Conversely, a DC electric power can be supplied from the DC distribution board 2 to the AC distribution board 1. In other words, the DC electric power can be converted into an AC electric power by the inverter 6 so as to be supplied to the AC power feed line Wa.

The power distribution system uses the commercial AC power source as an AC power source and the solar battery 3 and the secondary cell 5 as a DC power source. A controller 7 includes a power distribution control unit 7a for changing power sources for supplying an electric power to an outlet C (AC outlet Ca, DC outlet Cd) based on the power supply amounts from the power sources (i.e., power distribution control unit for varying a ratio of electric power amounts outputted from the power sources) and a display control unit 7b for changing a display of a display unit X provided in the outlet C based on the power sources used in supplying the electric power. Hereinafter, a power distribution and display control performed by the controller 7 will be described.

The controller 7 monitors the electric power supplied from the commercial AC power source, the electric power amount generated by the solar battery 3, the charging level of the secondary cell 5, the AC electric power supplied from the AC distribution board 1 to the AC power feed line Wa, and the DC electric power supplied from the DC distribution board 2 to the DC power feed line Wd. Further, the controller 7 controls the converter 2a, the charger and discharger 2b, the inverter 6 or the switches included in the AC distribution board 1 and the DC distribution board 2, such that the electric power can be transferred between the AC distribution board 1 and the DC distribution board 2, based on monitoring results, thereby performing the power distribution control.

More specifically, the secondary cell 5 is charged with the electric power generated by the solar battery 3 or the electric power supplied from the commercial AC power source via the converter 2a and the charger and discharger 2b. The controller 7 executes a first power surplus mode if the secondary cell 5 is fully charged (100% charging) and the electric power amount generated from the solar battery 3 is not less than 10% of rating. Further, the controller 7 executes a second power surplus mode if the charging level of the secondary cell 5 is 80% or more, or if the charging level of the secondary cell 5 is 30% or more and the electric power amount generated from the solar battery 3 is not less than 30% of rating.

In the first power surplus mode, only the solar battery 3 is used as a power source. In this mode, the DC outlet Cd in the DC power feed line Wd is supplied with the electric power generated from the solar battery 3 via the power conditioner 4 and the converter 2a. Further, the AC outlet Ca in the AC power feed line Wa is supplied with the electric power generated from the solar battery 3 via the power conditioner 4. That is, the solar battery 3 serves as the power source and the electric power amount supplied from the commercial AC power source is zero.

In the second power surplus mode, the solar battery 3 and the secondary cell 5 are used as the power sources. In this mode, the DC outlet Cd in the DC power feed line Wd is supplied with the charged electric power of the secondary cell 5 and the electric power generated from the solar battery 3 via the power conditioner 4 and the converter 2a. Further, the AC outlet Ca in the AC power feed line Wa is supplied with the electric power generated from the solar battery 3 via the power conditioner 4 and the charged electric power of the secondary cell 5 via the inverter 6. In other words, the solar battery 3 and the secondary cell 5 serve as the power sources and no electric power is supplied from the commercial AC power source.

Further, the controller 7 executes a first commercial power combination mode if the charging level of the secondary cell 5 is 30% or more and the electric power amount generated by the solar battery 3 is less than 30% of rating. Furthermore, the controller 7 executes a second commercial power combination mode if the charging level of the secondary cell 5 is less than 30% and the electric power amount generated by the solar battery 3 is not less than 30% of rating.

In the first commercial power combination mode, the solar battery 3, the secondary cell 5 and the commercial AC power source are used in combination as power sources. In this mode, the DC outlet Cd in the DC power feed line Wd is supplied with the charged electric power from the secondary cell 5, the electric power generated from the solar battery 3 via the power conditioner 4 and the converter 2a, and the electric power from the commercial AC power source via the converter 2a. Further, the AC outlet Ca in the AC power feed line Wa is supplied with the electric power from the commercial AC power source, the electric power generated from the solar battery 3 via the power conditioner 4, and the charged electric power from the secondary cell 5 via the inverter 6. As a result, the commercial AC power source, the solar battery 3 and the secondary cell 5 all serve as the power sources.

In the second commercial power combination mode, the solar battery 3 and the commercial AC power source are used in combination as the power sources. In this mode, the DC outlet Cd in the DC power feed line Wd is supplied with the electric power generated from the solar battery 3 via the power conditioner 4 and the converter 2a, and the electric power from the commercial AC power source via the converter 2a. Further, the AC outlet Ca in the AC power feed line Wa is supplied with the electric power from the commercial AC power source, and the electric power generated from the solar battery 3 via the power conditioner 4. In this case, the commercial AC power source and the solar battery 3 serve as the power sources.

Further, if the electric power amount generated by the solar battery 3 and the charging level of the secondary cell 5 do not fall within the ranges to satisfy the conditions of the first and second power surplus modes and the first and second commercial power combination modes, the controller 7 executes a commercial power consumption mode in which the electric power from the commercial AC power source is solely supplied to the DC outlet Cd and the AC outlet Ca. The commercial power consumption mode is further divided into a first commercial power consumption mode from 22:00 PM to 07:00 AM having the lowest electricity rate (electricity charge), a second commercial power consumption mode from 07:00 AM to 10:00 AM having the second lowest electricity rate, and a third commercial power consumption mode from 10:00 AM to 22:00 PM having the highest electricity rate. A mode is selected based on the current time. In the commercial power consumption mode, only the commercial AC power source serves as the power source.

As described above, the controller 7 selects one of the seven power distribution control modes (including the first power surplus mode, the second power surplus mode, the first commercial power combination mode, the second commercial power combination mode, the first commercial power consumption mode, the second commercial power consumption mode and the third commercial power consumption mode) based on the power supply capacities of the respective power sources. Further, the power distribution control modes are not limited to the above-mentioned seven modes and may further include, for example, a mode in which, as a condition, the predicted and generated electric power amount of the solar battery 3 is included based on the weather and the weather forecast.

Further, in this embodiment, the power distribution control of the power sources may be performed in three modes including the power surplus mode having only the DC power source (the solar battery 3 and the secondary cell 5), the commercial power combination mode having both the commercial AC power source and the DC power source, and the commercial power consumption mode having only the commercial AC power source. The above-mentioned seven modes are obtained by further dividing these three modes.

Further, the power distribution control of the power sources may be switched among five modes including the first power surplus mode, the second power surplus mode, the first commercial power combination mode, the second commercial power combination mode, and the commercial power consumption mode. The above-mentioned seven modes are obtained by further dividing the commercial power consumption mode based on the electricity rates (electricity charges). Alternatively, the first and second commercial power combination modes may be subdivided based on the rates (charges) in the same way as the first to third commercial power consumption modes.

Further, the power distribution control of the power sources may be changed among three modes including a mode using only the solar battery 3, a mode using a combination of the solar battery 3 and the secondary cell 5, and a mode including the commercial AC power source as a power source; or between two modes of a mode including the commercial AC power source as a power source and a mode using power sources other than the commercial AC power source.

Meanwhile, the AC power feed line Wa is provided with the AC outlet Ca serving as a power outlet, and the DC power feed line Wd is provided with the DC outlet Cd serving as a power outlet. The AC outlet Ca and the DC outlet Cd are installed on the wall of each room.

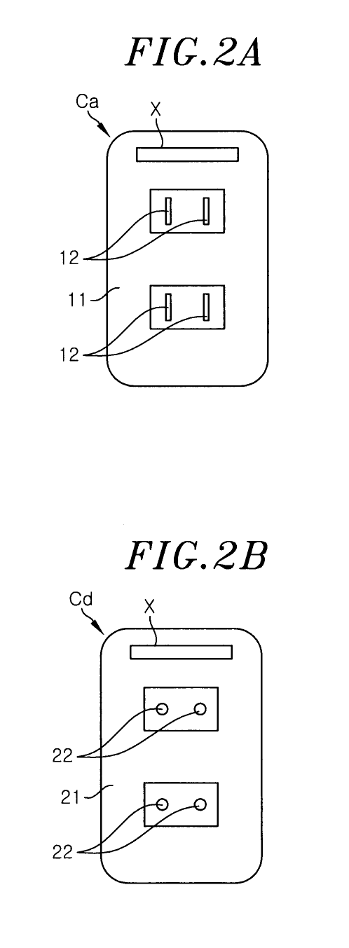

The AC outlet Ca includes, as shown in FIG. 2A, a body 11, rectangular insertion slots 12 formed on the front surface of the body 11 to receive a pair of flat blades of an AC plug electrically connected to an AC appliance (not shown), and a display unit X formed at an upper portion of the body 11, the display unit X using an LED as a light source. A light emitting surface of the display unit X is provided to be exposed to the interior when the outlet is installed on the wall surface or the like.

The DC outlet Cd includes, as shown in FIG. 2B, a body 21, circular insertion slots 22 formed on the front surface of the body 21 to receive a pair of cylindrical pins of a DC plug electrically connected to a DC appliance (not shown), and a display unit X formed at an upper portion of the body 21, the display unit X using an LED as a light source. A light emitting surface of the display unit X is arranged to be exposed to the interior when the outlet is installed on the wall surface or the like.

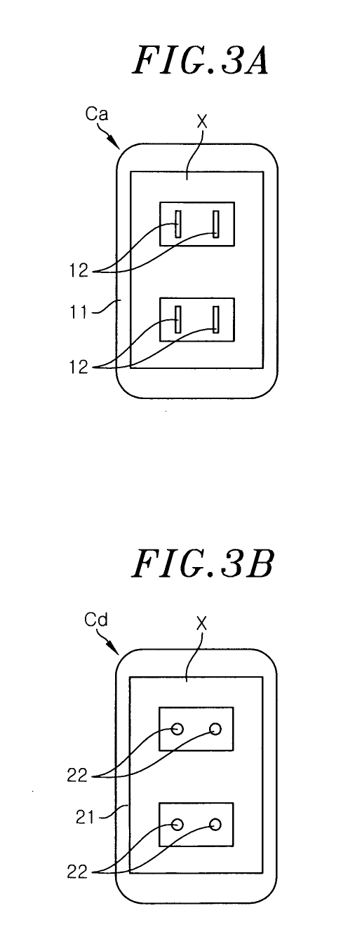

Although the display unit X is provided at the upper portion of each of the bodies 11 and 21 in FIGS. 2A and 2B, the display unit X may be provided on the almost entire surface of each of the bodies 11 and 21 as shown in FIGS. 3A and 3B.

The controller 7 controls the display of the display unit X of each of the DC outlet Cd and the AC outlet Ca in accordance with the selected power distribution control mode as described above. The display unit X includes, e.g., seven LEDs (or one LED capable of emitting seven colors) emitting different colors corresponding to the modes. The controller 7 controls the display unit X to change the light emitting color thereof correspondingly to the seven power distribution control modes, thereby notifying a user of the power source(s) currently used in the power supply of the system.

In other words, the controller 7 performs a power distribution control for changing the power sources based on the power supply amounts of the respective power sources and performs a display control for changing the display of the display unit X based on the power sources used in the power supply. Accordingly, the user can easily realize which power sources are currently used in the power supply through the display unit X of the outlet C (the AC outlet Ca and the DC outlet Cd) installed in the house. Consequently, it is possible to easily notify the user of the change of the power sources, and to motivate the user to save electric power and reduce the electricity rate.

As an example of display control, the display may be changed in different colors corresponding to the power distribution control modes as follows.

First power surplus mode: Pink

Second power surplus mode: Red

First commercial power combination mode: Orange

Second commercial power combination mode: Yellow

First commercial power consumption mode: Green

Second commercial power consumption mode: Blue

Third commercial power consumption mode: Violet

Alternatively, the color or the depth of color may be continuously varied from dark red to light pink in accordance with the power distribution control modes as follows.

First power surplus mode: Dark red

Second power surplus mode: Light red

First commercial power combination mode: Very light red

Second commercial power combination mode: Between red and pink

First commercial power consumption mode: Very dark pink

Second commercial power consumption mode: Dark pink

Third commercial power consumption mode: Light pink

Further, the controller 7 may cause the display of the display unit X of each of the AC outlet Ca and the DC outlet Cd to flicker before a change of the mode (change of the power sources). For example, the controller 7 notifies the user in advance of the mode change by alternately turning on and off red and orange lights for, e.g., 10 minutes before the second power surplus mode for emitting a red light is changed into the first commercial power combination mode for emitting an orange light. In this case, before the mode change, a state having a long red light emitting time duration and a short orange light emitting time duration may be gradually changed to a state having a short red light emitting time duration and a long orange light emitting time duration. Upon completion of the mode change, there may be a state in which the orange light is continuously emitted.

Accordingly, since the display unit X alternately emits colored lights corresponding to the modes before and after the mode change, the user can be informed in advance of the mode change, i.e., the change of power sources. As a result, the user can be motivated to take actions (e.g., power on/off and adjustment) for electric power saving and reduction of electricity rates as soon as possible.

Further, the display unit X of the outlet C may include a liquid crystal monitor and/or a voice output device having a speaker, thereby providing information visually or voice notification, and it is not limited thereto.

### Second Embodiment

Although the controller 7 performs a power distribution control for changing the power sources based on the power supply amounts of the respective power sources in the first embodiment, the controller 7 may perform a power distribution control for changing the power sources based on the power demand amount at the side of the outlet C, i.e., loads.

In this case, the controller 7 determines the power demand amount by monitoring the AC electric power supplied to the AC power feed line Wa from the AC distribution board 1 and the DC electric power supplied to the DC power feed line Wd from the DC distribution board 2, or by acquiring information on the power consumption from the AC outlet Ca and the DC outlet Cd. Further, if the power demand amount is small, the solar battery 3 and/or the secondary cell 5 are/is used as the power sources/source. As the power demand amount increases, the commercial AC power source is used jointly with the solar battery 3 and/or the secondary cell 5.

If the power demand amount is large, the commercial AC power source is solely used as the power source. Further, in this embodiment, the controller 7 obtains in advance the changes in electric power capacities (maximum and minimum values of the available electric power capacities) of the solar battery 3 and the secondary cell 5 depending on the changes in the sunlight during the day and night. The change of the power sources is performed based on the power demand amount on the side of the outlet C, taking into account the calculated changes in the electric power capacities of the solar battery 3 and the secondary cell 5.

Alternatively, the controller 7 may perform a power distribution control to change the power sources based on both the power supply amounts of the respective power sources and the power demand amount on the side of the outlet C. In this case, the controller 7 sequentially monitors the electric power generated from the solar battery 3, the charged electric power of the secondary cell 5 and electric power demand amounts. Then, the controller 7 performs the power distribution control such that the solar battery 3 and the secondary cell 5 are mainly used and the commercial AC power source is not used if possible while maintaining a balance between the demand and the supply of electric power such that the power supply amount is equal to or greater than the power demand amount (Power Supply Amount≧Power Demand Amount).

Further, although the power distribution system having both the AC power feed line Wa and the DC power feed line Wd is described as an example in each of the above embodiments, the display control corresponding to the change of the power sources may be executed in the same way even in a power distribution system having any one of the AC power feed line Wa and the DC power feed line Wd. Further, the present invention may be also applied to a case of using the commercial AC power source and one of the solar battery 3 and the secondary cell 5, and a case of using only the solar battery 3 and the secondary cell 5.

While the invention has been shown and described with respect to the embodiments, it will be understood by those skilled in the art that various changes and modification may be made without departing from the scope of the invention as defined in the following claims.

1. A power control system, comprising:
a plurality of electric appliances; and
a power control device for controlling operations of the electric appliances,
wherein the electric appliances are assorted into one or more groups each including two or more electric appliances, and the power control device controls operations of the electric appliances on a group-by-group basis according to a plurality of control options prepared in advance based on state information of the electric appliances.

2. The power control system of claim 1, wherein the power control device is configured to change the control options depending on the kind and number of the electric appliances belonging to the same group as the state information.

3. The power control system of claim 1, wherein the groups include a group including a plurality of cooling and heating electric appliances, and wherein the power control device is configured to control the cooling and heating electric appliances in association with each other.

4. The power control system of claim 1, wherein the groups include a human detector for detecting a human existing in a monitoring region and notifying the power control device of presence or absence of the human, and wherein the power control device is configured to control the electric appliances by use of different control options when the human is detected by the human detector and when the human is not detected by the human detector.

5. The power control system of claim 1, wherein the groups include a group to which the electric appliances required to be operated at all times belong.

6. The power control system of claim 5, wherein the power control device is configured to receive a control command from a power company and to reduce power consumption by controlling the electric appliances other than the electric appliances required to be operated at all times, when the control command requests the power control device to reduce power consumption.

7. The power control system of claim 5, wherein the power control device is configured to receive an operation input setting an upper limit value of power consumption and to reduce power consumption by controlling the electric appliances other than the electric appliances required to be operated at all times, when it is determined that the power consumption is likely to exceed the upper limit value.

8. The power control system of claim 1, wherein the power control device is configured to detect failure of the electric appliances by confirming operation states of the electric appliances and releases the group to which the electric appliance under failure belongs upon detecting failure of one of the electric appliances.

9. The power control system of claim 1, wherein the power control device stores, as a threshold value, an average setting value acquired from use history information including use time, use frequency and setting content of the electric appliances and determines disposition of a dweller based on the threshold value to reflect the disposition of the dweller in selecting the control options.

10. The power control system of claim 1, further comprising:
a server device for making data communications with the power control device, wherein, when one of the electric appliances is replaced and identification information thereof is renewed, the power control device transmits the renewed identification information to the server device and acquires performance information of the electric appliance corresponding to the renewed identification information from the server device to change the control options pursuant to the performance information.

11. The power control system of claim 1, further comprising:
a server device for making data communications with the power control device, wherein the power control device transmits identification information of the electric appliances and measured power consumption of the electric appliances to the server device, and wherein the server device finds a statistical value of power consumption on the electric appliance having the same identification information as the identification information received and transmits a warning notice to the power control device if the power consumption received is out of a normal range set pursuant to the statistical value.
